(19) United States
(12) Patent Application Publication
(10) Pub. No.: US 2026/0132728 A1
(43) Pub. Date: May 14, 2026

(54) EXHAUST AFTERTREATMENT SYSTEM WITH FILTER CARTRIDGE ASSEMBLY

(71) Applicant: Cummins Emission Solutions Inc., Columbus, IN (US)

(72) Inventors: Daniel J. Hill, Redcar (GB); Andrew Critchley, Darlington (GB); Paul David Thompson, Bishop Auckland (GB)

(73) Assignee: Cummins Emission Solutions Inc., Columbus, IN (US)

(21) Appl. No.: 19/385,371

(22) Filed: Nov. 11, 2025

Related U.S. Application Data
(60) Provisional application No. 63/719,743, filed on Nov. 13, 2024.

(51) Int. Cl. F01N 13/00; B01D 46/24; B01D 53/94; F01N 3/021; F01N 3/10; F01N 3/28; F01N 13/18

(52) U.S. Cl. CPC F01N 13/009; B01D 46/2414; B01D 53/944; F01N 3/0217; F01N 3/106; F01N 3/2803; F01N 13/1827; F01N 13/1855; B01D 2259/4566; B01D 2265/02; B01D 2271/02; B01D 2279/30

(57) ABSTRACT

A filter cartridge assembly for an aftertreatment unit includes a diesel particulate filter assembly and a diesel oxidation catalyst assembly. The diesel particulate filter assembly includes a diesel particulate filter housing and a diesel particulate filter substrate assembly. The diesel particulate filter housing includes a first cylindrical body and a first arcuate flange extending from an edge of the first cylindrical body. The diesel oxidation catalyst assembly includes diesel oxidation catalyst housing and diesel oxidation catalyst substrate assembly. The diesel oxidation catalyst housing includes a second cylindrical body and a second arcuate flange extending from an edge of the second cylindrical body. The second arcuate flange is removably coupled to the first arcuate flange to releasably couple the diesel oxidation catalyst housing to the diesel particulate filter housing.

### CROSS-REFERENCE TO RELATED APPLICATIONS

This application claims the benefit of U.S. Provisional Application No. 63/719,743 filed Nov. 13, 2024, the entire contents of which are hereby incorporated by reference herein.

### TECHNICAL FIELD

The present application relates generally to systems and methods for filtering exhaust in an exhaust aftertreatment system of an internal combustion engine.

### BACKGROUND

Nitrogen oxide (NOₓ) compounds are emitted in exhaust from internal combustion engines, such as diesel engines. It is desirable to reduce NOₓ emissions to comply with environmental regulations, for example. To reduce NOₓ emissions, a reductant may be dosed into the exhaust by a dosing system and within an aftertreatment system. The reductant facilitates conversion of a portion of the exhaust into non-NOₓ emissions, such as nitrogen (N₂), carbon dioxide (CO₂), and water (H₂O), thereby reducing NOₓ emissions.

In some applications, it is desirable to capture particulates, such as soot, in the exhaust produced by an internal combustion engine and treated by an aftertreatment system to convert a portion of the exhaust into non-hydrocarbon emissions, such as converting carbon monoxide (CO) to carbon dioxide (CO₂) and/or converting unburned hydrocarbons to water (H₂O) and carbon dioxide (CO₂). By capturing the particulates and converting the portion of the exhaust into non-hydrocarbon emissions, the aftertreatment system may reduce an amount of particulates and hydrocarbon emissions in an output of the aftertreatment system. The aftertreatment system may include a filter cartridge assembly including a diesel oxidation catalyst (DOC) configured to facilitate at least a portion of the conversion of the portion of the exhaust into non-hydrocarbon emissions and diesel particulate filter (DPF) configured to facilitate capturing the particulates in the exhaust.

### SUMMARY

When operating the internal combustion engine, a catalyst operational lifespan of the diesel oxidation catalyst where the diesel oxidation catalyst no longer effectively converts the portion of the exhaust into non-hydrocarbon emissions may be reached faster than a filter operational lifespan of the diesel particulate filter where the diesel particulate filter no longer effectively captures the particulates in the exhaust. For example, when the internal combustion engine utilizes particular fuels (e.g., B100, poisoning fuels, biodiesel fuel, etc.), the diesel oxidation catalyst may become poisoned and no longer function effectively prior to the diesel particulate filter reaching the filter operational lifespan. As a result, the filter cartridge assembly may be replaced with another of the filter cartridge assembly while the diesel particulate filter still has a portion of the filter operational lifespan remaining. Certain embodiments of the present disclosure may address this issue.

In one embodiment, a filter cartridge assembly for an aftertreatment unit includes a diesel particulate filter assembly and a diesel oxidation catalyst assembly. The diesel particulate filter assembly includes a diesel particulate filter housing and a diesel particulate filter substrate assembly. The diesel particulate filter housing includes a first cylindrical body and a first arcuate flange extending from an edge of the first cylindrical body. The edge of the first cylindrical body and lateral edges of the first arcuate flange collectively define a first opening. The diesel particulate filter substrate assembly is disposed within the first cylindrical body. The diesel oxidation catalyst assembly includes diesel oxidation catalyst housing and diesel oxidation catalyst substrate assembly. The diesel oxidation catalyst housing includes a second cylindrical body and a second arcuate flange extending from an edge of the second cylindrical body. The second arcuate flange is removably coupled to the first arcuate flange to releasably couple the diesel oxidation catalyst housing to the diesel particulate filter housing. The edge of the second cylindrical body and lateral edges of the second arcuate flange collectively define a second opening. The diesel oxidation catalyst substrate assembly is disposed within the second cylindrical body.

In another embodiment, a filter cartridge assembly for an aftertreatment unit includes a diesel particulate filter assembly, a diesel oxidation catalyst assembly, and a fastener. The diesel particulate filter assembly includes a diesel particulate filter housing and a diesel particulate filter substrate assembly. The diesel particulate filter housing includes a first cylindrical body and a first arcuate flange extending from an edge of the first cylindrical body. The first arcuate flange includes a first aperture. The diesel particulate filter substrate assembly is disposed within the first cylindrical body. The diesel oxidation catalyst assembly includes diesel oxidation catalyst housing and diesel oxidation catalyst substrate assembly. The diesel oxidation catalyst housing includes a second cylindrical body and a second arcuate flange extending from an edge of the second cylindrical body. The second arcuate flange includes a second aperture aligned with one of the first aperture. The diesel oxidation catalyst substrate assembly is disposed within the second cylindrical body. The fastener is received by the first aperture and the second aperture to releasably couple the diesel oxidation catalyst housing to the diesel particulate filter housing.

In yet another embodiment, a filter cartridge assembly for an aftertreatment unit includes a diesel particulate filter assembly and a diesel oxidation catalyst assembly. The diesel particulate filter assembly includes a diesel particulate filter housing, a diesel particulate filter substrate assembly, and a first seal assembly having a first outer diameter. The diesel particulate filter housing includes a first cylindrical body and a first arcuate flange extending from an edge of the first cylindrical body. The diesel particulate filter substrate assembly is disposed within the first cylindrical body. The diesel oxidation catalyst assembly includes diesel oxidation catalyst housing, diesel oxidation catalyst substrate assembly, and a second seal assembly having a second outer diameter. The second outer diameter less than the first outer diameter. The diesel oxidation catalyst housing includes a second cylindrical body and a second arcuate flange extending from an edge of the second cylindrical body. The second arcuate flange is removably coupled to the first arcuate flange to releasably couple the diesel oxidation catalyst housing to the diesel particulate filter housing. The diesel oxidation catalyst substrate assembly is disposed within the second cylindrical body.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block schematic diagram of an example exhaust aftertreatment system;

FIG. 2 is a perspective view of an example aftertreatment unit of the exhaust aftertreatment system of FIG. 1;

FIG. 3 is another perspective view of the aftertreatment unit of FIG. 2;

FIG. 4 is an exploded perspective view of the aftertreatment unit of FIG. 2;

FIG. 5 is a cross-sectional view of the aftertreatment unit of FIG. 2, taken along plane A-A;

FIG. 6 is a cross-sectional view of a portion of the aftertreatment unit of FIG. 2, taken along plane A-A;

FIG. 7 is a view of Detail A of FIG. 5;

FIG. 8 is a view of Detail B of FIG. 5;

FIG. 9 is a perspective view of a filter cartridge assembly of the aftertreatment unit of FIG. 2;

FIG. 10 is a cross-sectional view of the filter cartridge assembly of FIG. 9, taken along plane B-B;

FIG. 11 is a perspective view of a diesel particulate filter assembly of the filter cartridge assembly of FIG. 9;

FIG. 12 is a perspective view of a portion of a diesel particulate filter housing of the diesel particulate filter assembly of FIG. 11;

FIG. 13 is a perspective view of a diesel oxidation catalyst assembly of the filter cartridge assembly of FIG. 9;

FIG. 14 is a perspective view of a portion of a diesel oxidation catalyst housing of the diesel oxidation catalyst assembly of FIG. 13;

It will be recognized that some or all of the Figures are schematic representations for purposes of illustration. The Figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and for sampling exhaust in an exhaust aftertreatment system of an internal combustion engine. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Internal combustion engines (e.g., diesel internal combustion engines, biodiesel internal combustion engines, etc.) produce exhaust that includes constituents, such as soot, NOₓ, N₂, CO₂, and/or hydrocarbons. In some applications, the internal combustion engines include exhaust aftertreatment systems that removes portions of the constituents from the exhaust and/or converts portions of the constituents into other compounds. For example, the exhaust aftertreatment systems may convert carbon monoxide (CO) to carbon dioxide (CO₂), convert hydrocarbons to water (H₂O) and carbon dioxide (CO₂), and/or capture particulates in the exhaust (e.g., in order to reduce the amount of the constituents, in order to convert the constituents into less harmful constituents, etc.).

The exhaust aftertreatment systems may convert constituents and capture particulates using an aftertreatment unit with a filter cartridge assembly that includes a diesel oxidation catalyst (DOC) that can convert constituents in the exhaust through oxidation and a diesel particulate filter (DPF) that can capture particulates in the exhaust. The DOC may have a catalyst operational lifespan corresponding to a first length of operating time that the DOC can effectively convert constituents and the DPF may have a filter operational lifespan corresponding to a second length of operating time that the DPF can effectively capture particulates, where the first length of operating time is different from the second length of operating time. As a result of the different lengths of operating time, the filter cartridge assembly may be replaced prior to the DPF reaching the filter operational lifespan or the DOC reaching the catalyst operational lifespan, either of which may result in a waste of a portion of an operational lifespan of the DPF or the DOC.

The DPF may include a DPF sealing element that forms a DPF seal between the DPF and a DPF sealing surface of an aftertreatment housing when the DPF is received by the aftertreatment housing to prevent the exhaust from flowing between the DPF and the DPF sealing surface. The DOC may include a DOC sealing element that forms a DOC seal between the DOC and a DOC sealing surface of the aftertreatment housing when the DOC is received by the aftertreatment housing to prevent the exhaust from flowing between the DOC and the DOC sealing surface. However, when the filter cartridge assembly is installed in the aftertreatment housing, the DOC sealing element may pass the DPF sealing surface before sealing against the DOC sealing surface. Contact between the DOC sealing element and the DPF sealing surface during installation may damage the DOC sealing element, allowing for the exhaust to leak past the DOC seal and reducing an amount of the constituents in the exhaust that are converted by the DOC.

Implementations described herein are related to a filter cartridge assembly that includes a DOC removably coupled to a DPF. As a result, the DOC or the DPF may be separately replaced after reaching their operational thresholds, allowing for DOC and the DPF to each reach their operational thresholds prior to being replaced.

Furthermore, the DOC sealing element has a smaller diameter than the DPF sealing element. In this way and others described below, contact between the DOC element and the DPF sealing surface is reduced when the filter cartridge assembly is installed into the aftertreatment housing, which may limit damage to the DOC element during installation of the filter cartridge assembly.

### II. Example Exhaust Aftertreatment System

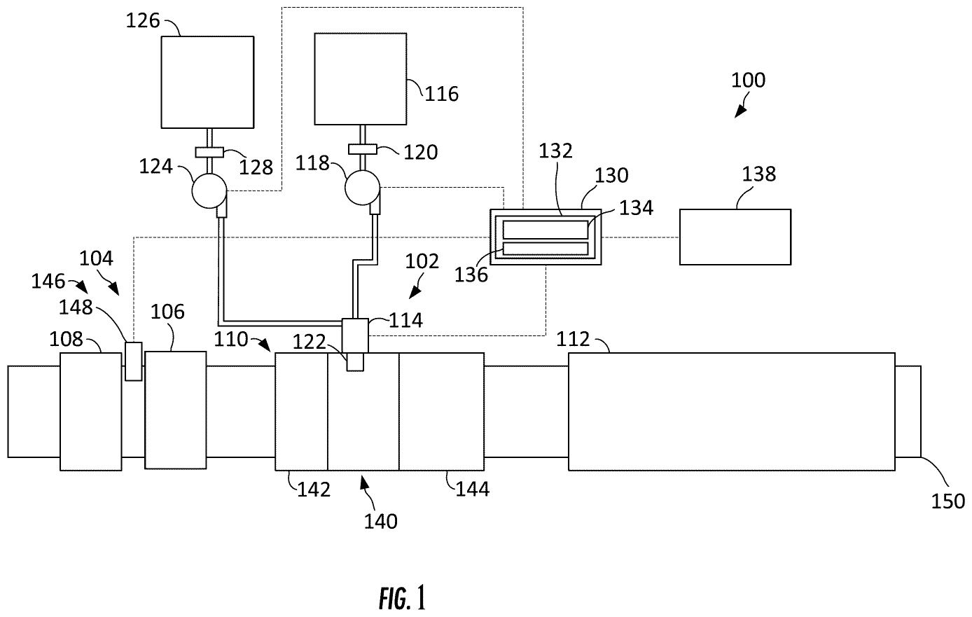

FIG. 1 depicts an exhaust aftertreatment system 100 having an example reductant delivery system 102 for an exhaust conduit system 104. The exhaust aftertreatment system 100 includes the reductant delivery system 102, a particulate filter (e.g., a diesel particulate filter (DPF)) 106, a decomposition chamber 110 (e.g., reactor, reactor pipe, etc.), an oxidation catalyst (e.g., a diesel oxidation catalyst (DOC) 108 and a SCR catalyst 112.

The DPF 106 is configured to remove particulate matter, such as soot, from exhaust flowing in the exhaust conduit system 104. The DPF 106 includes an inlet, where the exhaust is received, and an outlet, where the exhaust exits after having particulate matter substantially filtered from the exhaust and/or converting the particulate matter into carbon dioxide.

The DOC 108 is configured to assist in the reduction of carbon monoxide (CO) and/or hydrocarbons of the exhaust by oxidizing the CO into carbon dioxide (CO₂) and/or the hydrocarbons into water (H₂O) and CO₂. The DOC 108 is fluidly coupled to the DPF 106. In some implementations, DOC 108 may be positioned upstream of the DPF 106. For instance, the DOC 108 and the DPF 106 may be combined into a single unit with the DOC 108 positioned upstream of the DPF 106 in the single unit.

The decomposition chamber 110 is configured to convert a reductant into ammonia. The reductant may be, for example, urea, diesel exhaust fluid (DEF), Adblue®, a urea water solution (UWS), an aqueous urea solution (e.g., AUS32, etc.), and other similar fluids. The decomposition chamber 110 includes an inlet fluidly coupled to (e.g., fluidly configured to communicate with, etc.) the DPF 106 to receive the exhaust containing NOₓ emissions and an outlet for the exhaust, NOₓ emissions, ammonia, and/or reductant to flow to the SCR catalyst 112.

The reductant delivery system 102 includes a dosing module 114 (e.g., doser, etc.) configured to dose the reductant into the decomposition chamber 110 (e.g., via an injector). The dosing module 114 is mounted to the decomposition chamber 110 such that the dosing module 114 may dose the reductant into the exhaust flowing in the exhaust conduit system 104. The dosing module 114 may include an insulator interposed between a portion of the dosing module 114 and the portion of the decomposition chamber 110 on which the dosing module 114 is mounted.

The dosing module 114 is fluidly coupled to a reductant source 116. The reductant source 116 may include multiple of the reductant sources 116. The reductant source 116 may be, for example, a diesel exhaust fluid tank containing Adblue®. A reductant pump 118 (e.g., supply unit, etc.) is used to pressurize the reductant from the reductant source 116 for delivery to the dosing module 114. In some embodiments, the reductant pump 118 is pressure controlled (e.g., controlled to obtain a target pressure, etc.). The reductant pump 118 includes a reductant filter 120. The reductant filter 120 filters (e.g., strains, etc.) the reductant prior to the reductant being provided to internal components (e.g., pistons, vanes, etc.) of the reductant pump 118. For example, the reductant filter 120 may inhibit or prevent the transmission of solids (e.g., solidified reductant, contaminants, etc.) to the internal components of the reductant pump 118. In this way, the reductant filter 120 may facilitate prolonged desirable operation of the reductant pump 118. In some embodiments, the reductant pump 118 is coupled to a chassis of a vehicle associated with the exhaust aftertreatment system 100.

The dosing module 114 includes an injector 122. The injector 122 is configured to dose the reductant into the exhaust (e.g., within the decomposition chamber 110, etc.). In some embodiments, the dosing module 114 may include multiple of the injectors 122 configured to dose the reductant into the exhaust. In some embodiments, the reductant delivery system 102 also includes an air pump 124. In these embodiments, the air pump 124 draws air from an air source 126 (e.g., air intake, etc.) and through an air filter 128 disposed upstream of the air pump 124. Additionally, the air pump 124 provides the air to the dosing module 114 via a conduit. In these embodiments, the dosing module 114 is configured to mix the air and the reductant into an air-reductant mixture and to provide the air-reductant mixture into the decomposition chamber 110. In other embodiments, the reductant delivery system 102 does not include the air pump 124 or the air source 126. In such embodiments, the dosing module 114 is not configured to mix the reductant with air.

The dosing module 114 and the reductant pump 118 are also electrically or communicatively coupled to a reductant delivery system controller 130. The reductant delivery system controller 130 is configured to control the dosing module 114 to dose the reductant into the decomposition chamber 110. The reductant delivery system controller 130 may also be configured to control the reductant pump 118.

The reductant delivery system controller 130 includes a processing circuit 132. The processing circuit 132 includes a processor 134 and a memory 136. The processor 134 may include a microprocessor, an application-specific integrated circuit (ASIC), a field-programmable gate array (FPGA), etc., or combinations thereof. The memory 136 may include, but is not limited to, electronic, optical, magnetic, or any other storage or transmission device capable of providing a processor, ASIC, FPGA, etc. with program instructions. This memory 136 may include a memory chip, Electrically Erasable Programmable Read-Only Memory (EEPROM), Erasable Programmable Read Only Memory (EPROM), flash memory, or any other suitable memory from which the reductant delivery system controller 130 can read instructions. The instructions may include code from any suitable programming language. The memory 136 may include various modules that include instructions which are configured to be implemented by the processor 134.

In various embodiments, the reductant delivery system controller 130 is configured to communicate with a central controller 138 (e.g., engine control unit (ECU)), engine control module (ECM), etc.) of an internal combustion engine having the exhaust aftertreatment system 100. In some embodiments, the central controller 138 and the reductant delivery system controller 130 are integrated into a single controller.

In some embodiments, the central controller 138 is communicable with a display device (e.g., screen, monitor, touch screen, heads up display (HUD), indicator light, etc.). The display device may be configured to change state in response to receiving information from the central controller 138. For example, the display device may be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller 138. By changing state, the display device may provide an indication to a user (e.g., operator, etc.) of a status (e.g., operation, in need of service, etc.) of the reductant delivery system 102.

The decomposition chamber 110 is located upstream of the SCR catalyst 112. As a result, the reductant is injected upstream of the SCR catalyst 112 such that the SCR catalyst 112 receives a mixture of the reductant and exhaust. The reductant droplets undergo the processes of evaporation, thermolysis, and hydrolysis to form non-NOₓ emissions (e.g., gaseous ammonia, etc.) within the exhaust conduit system 104.

The SCR catalyst 112 is configured to assist in the reduction of NOₓ emissions by accelerating a NOₓ reduction process between the ammonia and the NOₓ of the exhaust into diatomic nitrogen, water, and/or carbon dioxide. The SCR catalyst 112 includes an inlet fluidly coupled to the decomposition chamber 110 from which exhaust and reductant are received and an outlet fluidly coupled to an end of the exhaust conduit system 104.

In some implementations, the DPF 106 may be positioned downstream of the decomposition chamber 110. For instance, the DPF 106 and the SCR catalyst 112 may be combined into a single unit. In some implementations, the dosing module 114 may instead be positioned downstream of a turbocharger or upstream of a turbocharger.

In various embodiments, the exhaust aftertreatment system 100 also includes a mixing assembly 140 (e.g., mixer, multi-stage mixer, etc.). The mixing assembly 140 is disposed between a decomposition chamber upstream portion 142 and a decomposition chamber downstream portion 144. Together, the decomposition chamber upstream portion 142, the mixing assembly 140, and the decomposition chamber downstream portion 144, form the mixing assembly 140. The dosing module 114 is coupled to the mixing assembly 140 and the injector 122 is configured to dose the reductant into the mixing assembly 140. As will be explained in more detail herein, the mixing assembly 140 functions to mix the exhaust received from the decomposition chamber upstream portion 142 with the reductant provided by the mixing assembly 140 and provide the decomposition chamber downstream portion 144 with exhaust that have been mixed with the reductant.

The exhaust aftertreatment system 100 also includes a sampling unit 146. In various embodiments, the sampling unit is configured to sample the exhaust proximate the DPF 106. For example, a portion of the sampling unit 146 may be positioned between the DOC 108 and the DPF 106 to sample the exhaust exiting the DOC 108 before the exhaust enters the DPF 106. However, in other embodiments, the sampling unit 146 is additionally or alternatively positioned proximate the SCR catalyst 112, or proximate the decomposition chamber 110. In still other embodiments, the sampling unit 146 is additionally or alternatively positioned downstream of the DPF 106 or upstream of the DOC 108 (e.g., downstream of the DPF 106 and upstream of the decomposition chamber 110, downstream of the decomposition chamber 110 and upstream of the SCR catalyst 112, etc.). The sampling unit 146 may include at least one sensor 148 configured to generate sensor data associated with the exhaust aftertreatment system 100. For example, the sensors 148 may be a CO sensor configured to determine an amount (e.g., level, volume, etc.) of CO in the exhaust flowing through the sampling unit 146, a hydrocarbon sensor configured to determine an amount of hydrocarbons in the exhaust flowing through the sampling unit, a NOₓ sensor (e.g., a Continental 2.8 NOₓ sensor, a Continental 2.0 NOₓ sensor, a Bosch 4.0 NOₓ sensor, etc.) configured to determine an amount of NOₓ in the exhaust flowing through the sampling unit 146, a particulate sensor configured to determine an amount of particulates in the exhaust flowing through the sampling unit 146, and/or a temperature sensor configured to determine a temperature of the exhaust flowing through the sampling unit 146. The sensors 148 are configured to communicate with the reductant delivery system controller 130. For example, an amount of CO determined by the sensors 148 may be provided to the reductant delivery system controller 130, an amount of hydrocarbons determined by the sensors 148 may be provided to the reductant delivery system controller 130, and/or an amount of particulates determined by the sensors 148 may be provided to the reductant delivery system controller 130.

In various embodiments, the outlet of the SCR catalyst 112 is fluidly coupled to an exit passage 150 (e.g., exhaust pipe, exhaust passage, etc.). The exit passage 150 may be fluidly coupled to the end of the exhaust conduit system 104 (e.g., an exhaust pipe, etc.). The exit passage 150 may define an exhaust flow-by area that the exhaust flows through while flowing through the exit passage 150.

While the exhaust aftertreatment system 100 has been shown and described in the context of use with a diesel internal combustion engine, it is understood that the exhaust aftertreatment system 100 may be used with other internal combustion engines, such as gasoline internal combustion engines, hybrid internal combustion engines, propane internal combustion engines, and other similar internal combustion engines. In some embodiments, the exhaust aftertreatment system 100 is used with biodiesel internal combustion engines.

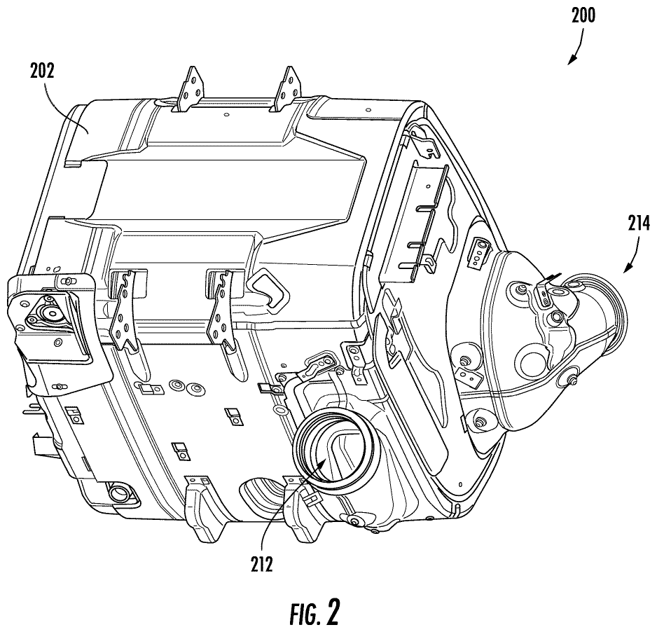

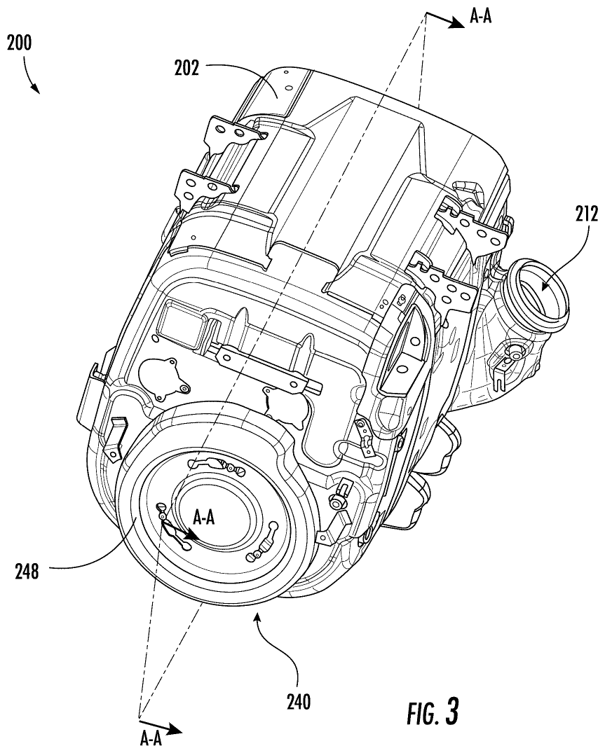

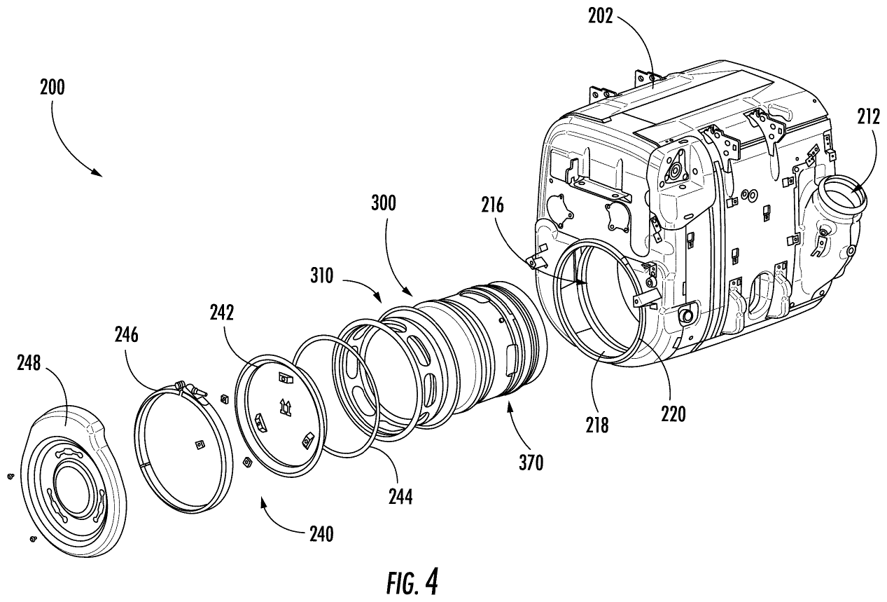

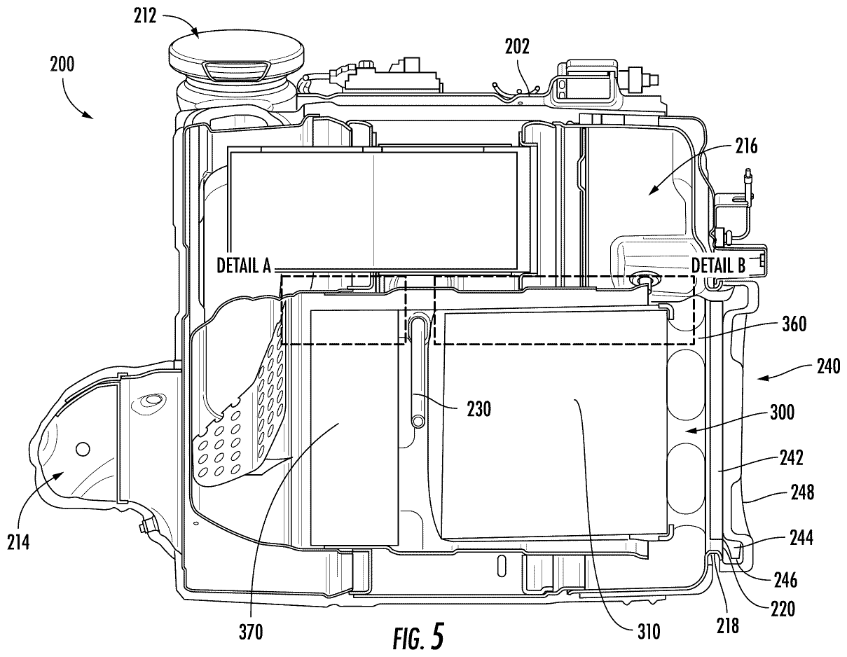

Referring now to FIGS. 2-5, the exhaust aftertreatment system 100 includes an aftertreatment unit 200 that includes other components of the exhaust aftertreatment system 100. According to the exemplary embodiment shown in FIGS. 2-5, the aftertreatment unit 200 includes the DPF 106, the DOC 108, and the sampling unit 146. In other embodiments, the aftertreatment unit 200 includes other components of the exhaust aftertreatment system 100 (e.g., the SCR catalyst 112, the decomposition chamber 110, etc.) and the sampling unit 146.

### III. Example Filter Cartridge Assembly

The aftertreatment unit 200 includes a filter cartridge assembly 300 (e.g., a modular filter cartridge assembly, a serviceable filter cartridge assembly, a replaceable filter cartridge assembly, etc.). As is explained in more detail herein, the filter cartridge assembly 300 includes the DPF 106 and the DOC 108 and is configured to facilitate replacing the DPF 106 and/or the DOC 108 with another of the DPF 106 and/or the DOC 108 when an operational lifespan of the DPF 106 and/or the DOC 108 has been reached or exceeded. As is also explained in more detail herein, the filter cartridge assembly 300 allows for the DPF 106 and the DOC 108 to be separately replaced such that the DPF 106 may be replaced without replacing the DOC 108 when a filter operational lifespan of the DPF 106 has been exceeded and such that the DOC 108 may be replaced without replacing the DPF 106 when a catalyst operational lifespan of the DOC 108 has been exceeded. In some applications, the filter operational lifespan of the DPF 106 and the catalyst operational lifespan of the DOC 108 may be different amounts of time. For example, for biodiesel internal combustion engines, the catalyst operational lifespan of the DOC 108 may be shorter than the filter operational lifespan of the DPF 106. Therefore, the filter cartridge assembly 300 may be more desirable than other systems which do not allow for diesel oxidation catalysts to be replaced separately from diesel particulate filters.

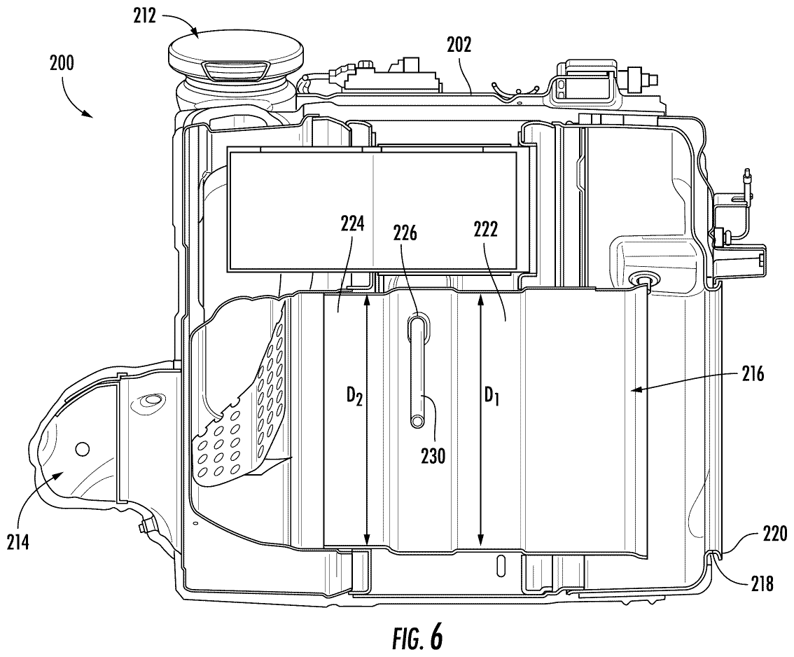

The aftertreatment unit 200 also includes an aftertreatment housing 202 (e.g., a body, an aftertreatment body, etc.). According to the example embodiment shown in FIGS. 2-6, the aftertreatment housing 202 is configured to receive the filter cartridge assembly 300 including the DPF 106 and the DOC 108. In other embodiments, the aftertreatment housing 202 is configured to receive the filter cartridge assembly 300 including other components of the exhaust aftertreatment system 100 (e.g., the decomposition chamber 110, the SCR catalyst 112, etc.) when the filter cartridge assembly 300 includes the other components. The aftertreatment housing 202.

The aftertreatment housing 202 includes an inlet opening 212 (e.g., an upstream inlet, etc.). The inlet opening 212 is configured to be coupled to an upstream exhaust conduit (e.g., a conduit of a turbocharger, etc.) and is configured to receive exhaust from an upstream component (e.g., a turbocharger, etc.). The inlet opening 212 is configured to provide the exhaust received from the upstream component to an upstream side of the filter cartridge assembly 300 positioned within the aftertreatment housing 202. In some embodiments, the inlet opening 212 is configured to provide the exhaust received from the upstream component to an upstream side of the DOC 108 positioned within the aftertreatment housing 202 (e.g., when the filter cartridge assembly 300 includes the DOC 108, etc.). In other embodiments, the inlet opening 212 is configured to provide the exhaust received from the upstream component to an upstream side of the DPF 106 (e.g., when the filter cartridge assembly 300 includes the DPF 106 is positioned upstream of the DOC 108, etc.), an upstream side of the decomposition chamber 110 (e.g., when the filter cartridge assembly 300 includes the decomposition chamber 110, etc.), or an upstream side of the SCR catalyst 112 (e.g., when the filter cartridge assembly includes the decomposition chamber 110, etc.). The inlet opening 212 may define an inlet flow-by area that the exhaust flows through while flowing through the inlet opening 212.

The aftertreatment housing 202 includes an exit opening 214 (e.g., a downstream outlet, etc.). The exit opening 214 is configured to be coupled to a downstream exhaust conduit (e.g., the exit passage 150, etc.) and is configured to provide exhaust to a downstream component of the exhaust aftertreatment system 100 (e.g., the decomposition chamber 110, the SCR catalyst 112, the exit passage 150, etc.). The exit opening 214 is configured to receive the exhaust from a downstream side of the filter cartridge assembly 300 positioned within the aftertreatment housing 202. In some embodiments, the exit opening 214 is configured to receive the exhaust from a downstream side of the DPF 106 positioned within the aftertreatment housing 202 (e.g., when the filter cartridge assembly 300 includes the DPF 106, etc.). In other embodiments, the exit opening 214 is configured to receive the exhaust from a downstream side of the DOC 108 (e.g., when the filter cartridge assembly 300 includes the DOC 108 is positioned downstream of the DPF 106, etc.), a downstream side of the decomposition chamber 110, or a downstream side of the SCR catalyst 112. The exit opening 214 may define an exit flow-by area that the exhaust flows through while flowing through the exit opening 214.

The aftertreatment housing 202 includes a cavity 216 fluidly coupled with the inlet opening 212 and the exit opening 214 and is configured to provide exhaust from the inlet opening 212 to the exit opening 214. The cavity 216 may also be configured to receive the filter cartridge assembly 300 such that the exhaust is processed by the filter cartridge assembly 300 while flowing from the inlet opening 212 to the exit opening 214 For example, when the filter cartridge assembly 300 includes the DPF 106 and the DOC 108, the exhaust may be processed by the DPF 106 and the DOC 108 while flowing from the inlet opening 212 to the exit opening 214.

The aftertreatment housing 202 includes a cavity aperture 218 extending through the aftertreatment housing 202. The cavity aperture 218 is configured to provide access to the cavity 216 through the aftertreatment housing 202. The cavity 216 is configured to receive the filter cartridge assembly 300 when the filter cartridge assembly 300 is being received by the cavity 216. For example, when installing the filter cartridge assembly 300 into the cavity 216, an operator may insert the filter cartridge assembly 300 through the cavity aperture 218 into the cavity 216.

The aftertreatment housing 202 includes a coupling interface 220 configured to interface with the filter cartridge assembly 300 to releasably couple the filter cartridge assembly 300 to the aftertreatment housing 202. For example, the coupling interface 220 may be a lip extending from the cavity aperture 218 configured to be engaged by the filter cartridge assembly 300 to releasably couple the filter cartridge assembly 300 to the aftertreatment housing 202. In some embodiments, the coupling interface 220 extends outward from the cavity aperture 218. In other embodiments, the coupling interface 220 extends inward from the cavity aperture 218.

The cavity 216 includes a first inner surface 222 (e.g., first sealing surface, DPF sealing surface, etc.) of the aftertreatment housing 202 and a second inner surface 224 (e.g., a second sealing surface, DOC sealing surface, etc.) of the aftertreatment housing 202 positioned upstream from the first inner surface 222. The first inner surface 222 is configured to form a first seal with a first portion (e.g., a downstream portion, etc.) of the filter cartridge assembly 300 when the filter cartridge assembly 300 is received by the aftertreatment housing 202 such that the exhaust flowing through the cavity 216 cannot flow around an outside of the first portion of the filter cartridge assembly 300. The second inner surface 224 is configured to form a second seal with a second portion (e.g., an upstream portion, etc.) of the filter cartridge assembly 300 when the filter cartridge assembly 300 is received by the aftertreatment housing 202 such that the exhaust flowing through the cavity 216 cannot flow around an outside of the second portion of the filter cartridge assembly 300. The first inner surface 222 has a first diameter D₁. The second inner surface 224 has a second inner diameter D₂ that is less than the first diameter D₁ of the first inner surface 222 In other embodiments, the first diameter D₁ of the first inner surface 222 is equal to the second diameter D₂ of the second inner surface 224.

The aftertreatment housing 202 includes a sampling aperture 226 extending through the aftertreatment housing 202. The sampling aperture 226 is positioned between the first inner surface 222 and the second inner surface 224. The aftertreatment unit 200 includes a sampler tube 230 coupled to the aftertreatment housing 202, extending through the sampling aperture 226, and configured to provide the exhaust to the sensor 148 of the sampling unit 146. The sampler tube 230 extends into the cavity 216. The sampler tube 230 is configured to provide the exhaust from between the first portion of the filter cartridge assembly 300 and the second portion of the filter cartridge assembly 300 to the sensor 148 of the sampling unit 146. In some embodiments, the sampler tube 230 includes a plurality of sampler apertures. As the exhaust flows through the cavity 216, a portion of the exhaust may flow through any of the sampler apertures into the sampler tube 230 to be provided to the sensor 148 of the sampling unit 146. The sampler tube 230 may form a seal with the sampling aperture 226 to prevent the exhaust from flowing between the sampler tube 230 and the sampling aperture 226.

The aftertreatment unit 200 includes a sealing cap assembly 240 configured to removably couple the filter cartridge assembly 300 to the coupling interface 220 of the aftertreatment housing 202 when the filter cartridge assembly 300 is received by the aftertreatment housing 202. The sealing cap assembly 240 includes a cap 242, a cap seal 244 (e.g., a sealing element, etc.), and a cap lock 246. The cap 242 is configured to selectively cover the cavity aperture 218. For example, when the filter cartridge assembly 300 is received by the cavity 216 of the aftertreatment housing 202, the cap 242 may be placed over the cavity aperture 218 to prevent the exhaust flowing through the cavity 216 from flowing out of the cavity 216 through the cavity aperture 218. The cap seal 244 is configured to prevent the exhaust from flowing between the aftertreatment housing 202 and the cap 242. For example, the cap seal 244 may be a sealing element positioned between the aftertreatment housing 202 and the cap 242 configured to form a seal between the aftertreatment housing 202 and the cap 242 to prevent the exhaust from flowing between the aftertreatment housing 202 and the cap 242. The cap lock 246 is configured to releasably couple the filter cartridge assembly 300 and the cap 242 to the coupling interface 220 of the aftertreatment housing 202. For example, the cap lock 246 may be a locking band configured to be tightened around the filter cartridge assembly 300, the cap 242, and the coupling interface 220 to releasably couple the filter cartridge assembly 300 and the cap 242 to the coupling interface 220.

The sealing cap assembly 240 also includes a cap cover 248 (e.g., a cover, etc.). The cap cover 248 is configured to removably couple to the cap 242 to at least partially cover the cap 242 and/or the cap lock 246. The cap cover 248 may protect the cap 242 and/or the cap lock 246 to prevent the cap 242 and/or the cap lock 246 from being damaged, which could cause the exhaust to leak from the cavity 216. In some embodiments, the cap cover 248 is configured to be coupled to the cap 242 via fasteners.

The filter cartridge assembly 300 includes the DPF 106 configured as a diesel particulate filter assembly 310 (e.g., a filter assembly, a first cartridge assembly, etc.) and the DOC 108 configured as a diesel oxidation catalyst assembly 370 (e.g., a catalyst assembly, a second cartridge assembly, etc.). The diesel oxidation catalyst assembly 370 is configured to removably couple to the diesel particulate filter assembly 310 such that the DOC 108 or the DPF 106 may be independently replaced with another of the DOC 108 or the DPF 106, respectively.

The diesel particulate filter assembly 310 includes a diesel particulate filter housing 312 (e.g., a first housing, a first crown ring, a diesel particulate filter crown ring housing, a diesel particulate filter crown ring, etc.), a diesel particulate filter seal assembly 340 (e.g., a first seal assembly, etc.), a diesel particulate filter substrate assembly 350 (e.g., a first substrate, a particulate matrix, a diesel particulate filter substrate, etc.), and a mounting cap 360. The diesel particulate filter substrate assembly 350 is configured to remove particulates from the exhaust flowing through the diesel particulate filter assembly 310. The diesel particulate filter substrate assembly 350 is disposed within the diesel particulate filter housing 312. The diesel particulate filter housing 312 includes a diesel particulate filter cylindrical body 314 (e.g., a first cylindrical body, etc.) etc.) and a diesel particulate filter arcuate flange 330 (e.g., a first arcuate flange, first arced flange, a diesel particulate filter housing arcuate flange, etc.) extending from a diesel particulate filter cylindrical body edge 316 (e.g., a first edge, an inner edge, a diesel particulate filter housing edge, etc.) of the diesel particulate filter cylindrical body 314. The diesel particulate filter arcuate flange 330 has a first radius of curvature ρ₁. The diesel particulate filter seal assembly 340 is coupled to the diesel particulate filter assembly 310 and is configured to contact the first inner surface 222 of the cavity 216 such that a first seal is formed between the first inner surface 222 and the diesel particulate filter assembly 310 when the filter cartridge assembly 300 is received by the aftertreatment housing 202.

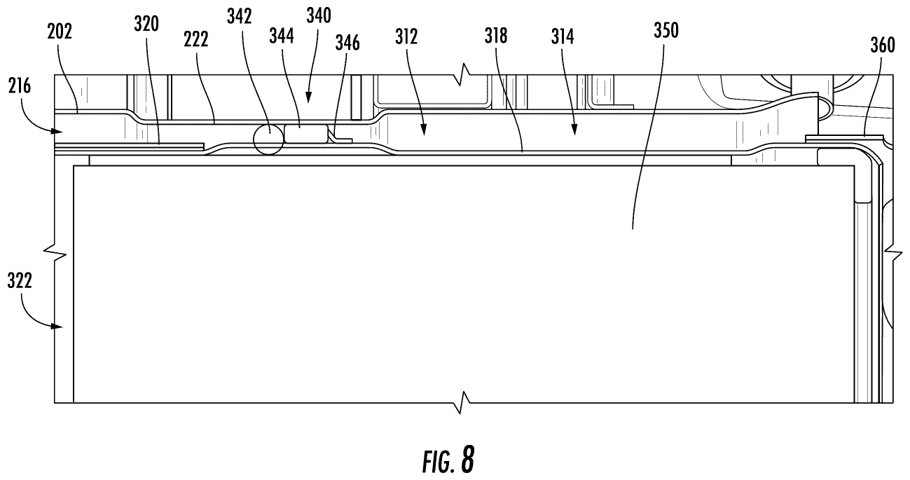

The diesel particulate filter cylindrical body 314 includes a diesel particulate filter body 318 (e.g., a filter body, etc.) and a diesel particulate filter annular body 320 (e.g., a first annular body, a first crown ring annular body, a diesel particulate filter crown ring body a first housing body, a diesel particulate filter housing body, etc.). The diesel particulate filter annular body 320 is coupled to the diesel particulate filter body 318. In some embodiments, the diesel particulate filter annular body 320 is coupled to an outer surface of the diesel particulate filter body 318. According to the exemplary embodiment shown in FIGS. 8-10, the diesel particulate filter seal assembly 340 is coupled to the outer surface of the diesel particulate filter body 318. In other embodiments, the diesel particulate filter seal assembly 340 is coupled to an outer surface of the diesel particulate filter annular body 320.

The diesel particulate filter body 318 defines a diesel particulate filter cavity 322 (e.g., a filter body opening, a first body cavity, etc.) extending through the diesel particulate filter body 318. The diesel particulate filter substrate assembly 350 may be at least partially disposed within the diesel particulate filter cavity 322. In some embodiments, the diesel particulate filter substrate assembly 350 may be coupled to the diesel particulate filter body 318 when the diesel particulate filter substrate assembly 350 is disposed within the diesel particulate filter cavity 322 of the diesel particulate filter body 318. The diesel particulate filter annular body 320 defines the diesel particulate filter cylindrical body edge 316 of the diesel particulate filter cylindrical body 314. For example, a first side (e.g., an inner side, a downstream side, etc.) of the diesel particulate filter annular body 320 may be coupled to the diesel particulate filter body 318 and an opposing second side (e.g., an outer side, an upstream side, etc.) of the diesel particulate filter annular body 320 may define the diesel particulate filter cylindrical body edge 316 such that the diesel particulate filter arcuate flange 330 extends from the diesel particulate filter annular body 320.

The diesel particulate filter cylindrical body edge 316 of the diesel particulate filter housing 312 and diesel particulate filter arcuate flange lateral edges 332 (e.g., first lateral edges, etc.) of the diesel particulate filter arcuate flange 330 collectively define a diesel particulate filter opening 334 (e.g., a first opening, a first sampling tube opening, etc.). The diesel particulate filter opening 334 extends from the diesel particulate filter cylindrical body edge 316 between the diesel particulate filter arcuate flange lateral edges 332. The diesel particulate filter arcuate flange 330 defines a diesel particulate filter arcuate flange aperture 336 (e.g., a first aperture, etc.) extending through the diesel particulate filter arcuate flange 330. In some embodiments, the diesel particulate filter body 318 extends past the diesel particulate filter cylindrical body edge 316 and blocks at least a portion of the diesel particulate filter openings 334.

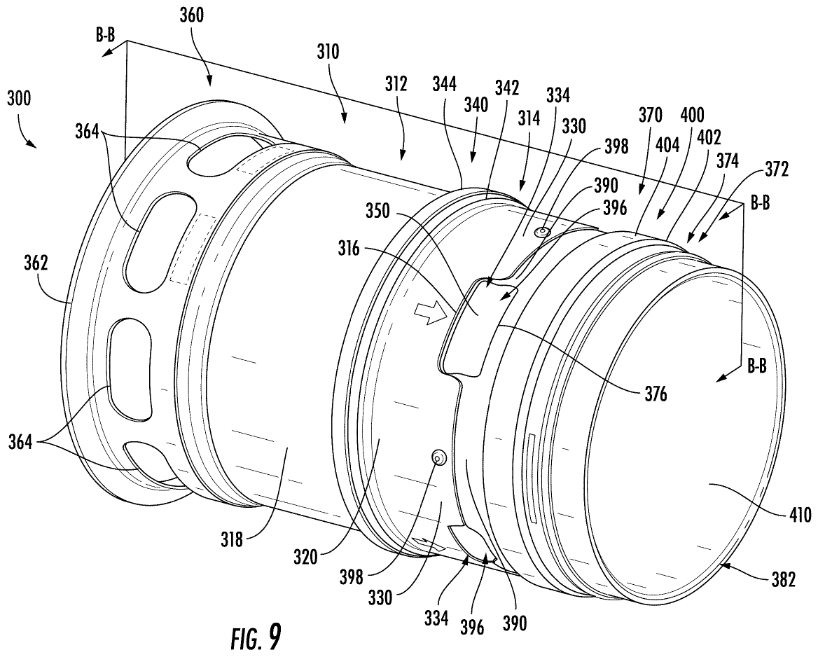

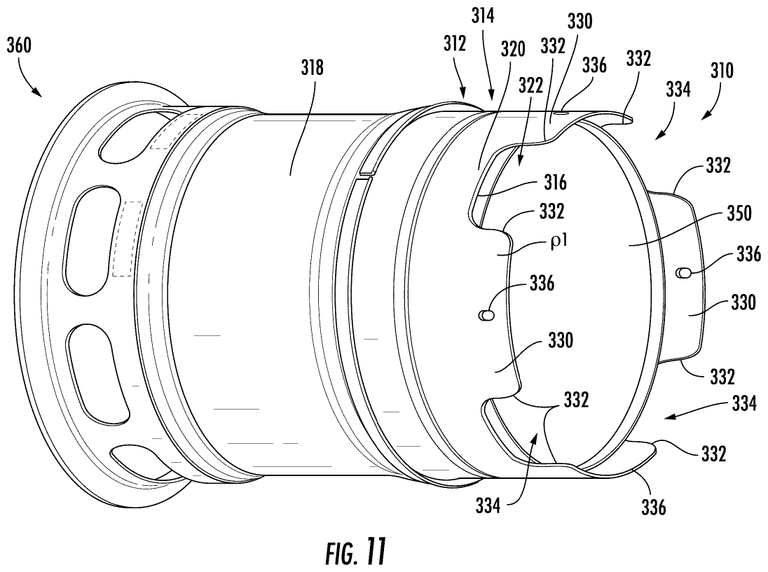

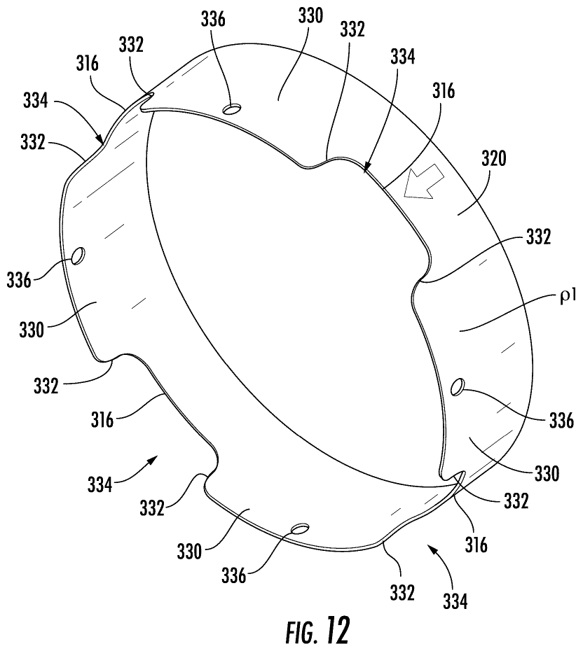

According to the exemplary embodiment shown in FIGS. 9, 11, and 12, the diesel particulate filter housing 312 includes a plurality of the diesel particulate filter arcuate flanges 330 (e.g., two of the diesel particulate filter arcuate flanges 330, three of the diesel particulate filter arcuate flanges 330, four of the diesel particulate filter arcuate flanges 330, etc.) extending from the diesel particulate filter cylindrical body edge 316 of the diesel particulate filter cylindrical body 314. The diesel particulate filter cylindrical body edge 316 of the diesel particulate filter housing 312 and the diesel particulate filter arcuate flange lateral edges 332 of the diesel particulate filter arcuate flanges 330 collectively define a plurality of the diesel particulate filter openings 334 (e.g., a second opening, a third opening, a fourth opening, etc.). For example, when the diesel particulate filter housing 312 includes two of the diesel particulate filter arcuate flanges 330, (i) the diesel particulate filter cylindrical body edge 316, a first of the diesel particulate filter arcuate flange lateral edges 332 of a first of the diesel particulate filter arcuate flanges 330, and a first of the diesel particulate filter arcuate flange lateral edges 332 of a second of the diesel particulate filter arcuate flanges 330 may collectively define a first of the diesel particulate filter openings 334 and (ii) the diesel particulate filter cylindrical body edge 316, an opposing second of the diesel particulate filter arcuate flange lateral edges 332 of the first of the diesel particulate filter arcuate flanges 330, and an opposing second of the diesel particulate filter arcuate flange lateral edges 332 of the second of the diesel particulate filter arcuate flanges 330 may collectively define a second of the diesel particulate filter openings 334. Each of the diesel particulate filter arcuate flanges 330 may define one of the diesel particulate filter arcuate flange apertures 336 extending through the diesel particulate filter arcuate flanges 330.

The diesel particulate filter seal assembly 340 includes a diesel particulate filter seal element 342 (e.g., a first seal element, etc.) a diesel particulate filter seal support 344 (e.g., a first seal support, etc.), and a diesel particulate filter seal retaining ring 346 (e.g., a first retaining ring, etc.). The diesel particulate filter seal element 342 is configured to contact the first inner surface 222 of the cavity 216 to form the first seal between the diesel particulate filter assembly 310 and the first inner surface 222 such that exhaust flowing through the diesel particulate filter assembly 310 cannot flow between the diesel particulate filter assembly 310 and the aftertreatment housing 202 (e.g., around an outside of the diesel particulate filter assembly 310, etc.). The diesel particulate filter seal element 342 may be formed from a silica rope. The diesel particulate filter seal support 344 is positioned downstream of the diesel particulate filter seal element 342. For example, the diesel particulate filter seal support 344 may be positioned further from the diesel particulate filter arcuate flange 330 than the diesel particulate filter seal element 342. The diesel particulate filter seal support 344 is configured to support the diesel particulate filter seal element 342 against a flow of the exhaust against the diesel particulate filter seal element 342. The diesel particulate filter seal support 344 may be formed from a wire mesh. The diesel particulate filter seal retaining ring 346 is coupled to the diesel particulate filter cylindrical body 314 downstream of the diesel particulate filter seal support 344. For example, the diesel particulate filter seal retaining ring 346 may be positioned further from the diesel particulate filter arcuate flange 330 than the diesel particulate filter seal support 344. The diesel particulate filter seal retaining ring 346 is configured to support the diesel particulate filter seal support 344 against the flow of the exhaust against the diesel particulate filter seal element 342. The diesel particulate filter seal assembly 340 has a first outer diameter OD₁. The first outer diameter OD₁ of the diesel particulate filter seal assembly 340 may correspond with the first diameter D₁ of the first inner surface 222 so that the diesel particulate filter seal assembly 340 and the first inner surface 222 form the first seal between the diesel particulate filter assembly 310 and the aftertreatment housing 202.

The mounting cap 360 is coupled to the diesel particulate filter cylindrical body 314. The mounting cap 360 may be coupled to and extend from a side of the diesel particulate filter cylindrical body 314 opposing the diesel particulate filter cylindrical body edge 316. The mounting cap 360 includes a mounting interface 362 configured to releasably couple to the coupling interface 220 to releasably couple the filter cartridge assembly 300 to the aftertreatment housing 202 when the filter cartridge assembly 300 is received by the aftertreatment housing 202. For example, when the filter cartridge assembly 300 is received by the aftertreatment housing 202, the diesel particulate filter seal retaining ring 346 may releasably couple the mounting interface 362 to the coupling interface 220 to releasably couple the filter cartridge assembly 300 to the aftertreatment housing 202. In some embodiments, the mounting interface 362 is configured to be engaged by a filter cartridge assembly tool configured to facilitate installation and removal of the filter cartridge assembly 300 from the aftertreatment housing 202. The mounting cap 360 defines a plurality of flow-through apertures 364 extending through the mounting cap 360. The flow-through apertures 364 may allow for the exhaust flowing through the filter cartridge assembly 300 to exit the filter cartridge assembly 300 and flow to the exit opening 214 of the aftertreatment housing 202. In other embodiments, the mounting cap 360 defines a single of the flow-through apertures 364.

The diesel oxidation catalyst assembly 370 includes a diesel oxidation catalyst housing 372 (e.g., a second housing, a second crown ring housing, a diesel oxidation catalyst crown ring, etc.), a diesel oxidation catalyst seal assembly 400 (e.g., a first seal assembly, and a diesel oxidation catalyst substrate assembly 410 (e.g., a second substrate, a catalyst matrix, a diesel oxidation catalyst substrate, etc.). The diesel oxidation catalyst substrate assembly 410 is configured to assist in the reduction of carbon monoxide (CO) and/or hydrocarbons of the exhaust flowing through the diesel oxidation catalyst assembly 370 by oxidizing the CO into carbon dioxide (CO₂) and/or the hydrocarbons into water (H₂O) and CO₂. The diesel oxidation catalyst substrate assembly 410 is disposed within the diesel oxidation catalyst housing 372. The diesel oxidation catalyst housing 372 includes a diesel oxidation catalyst cylindrical body 374 (e.g., a second cylindrical body, etc.) and a diesel oxidation catalyst arcuate flange 390 (e.g., a second arcuate flange, a second arced flange, a diesel oxidation catalyst crown ring arcuate flange, a diesel oxidation catalyst housing arcuate flange, etc.) extending from a diesel oxidation catalyst cylindrical body edge 376 (e.g., a second edge, an inner edge, a diesel oxidation catalyst housing edge, etc.) of the diesel oxidation catalyst cylindrical body 374. The diesel oxidation catalyst arcuate flange 390 is configured to releasably couple to the diesel particulate filter arcuate flange 330 of the diesel particulate filter assembly 310 to releasably couple the diesel oxidation catalyst assembly 370 to the diesel particulate filter assembly 310. The diesel oxidation catalyst seal assembly 400 is coupled to the diesel oxidation catalyst assembly 370 and is configured to contact the second inner surface 224 of the cavity 216 such that a second seal is formed between the second inner surface 224 and the diesel oxidation catalyst assembly 370 when the filter cartridge assembly 300 is received by the aftertreatment housing 202.

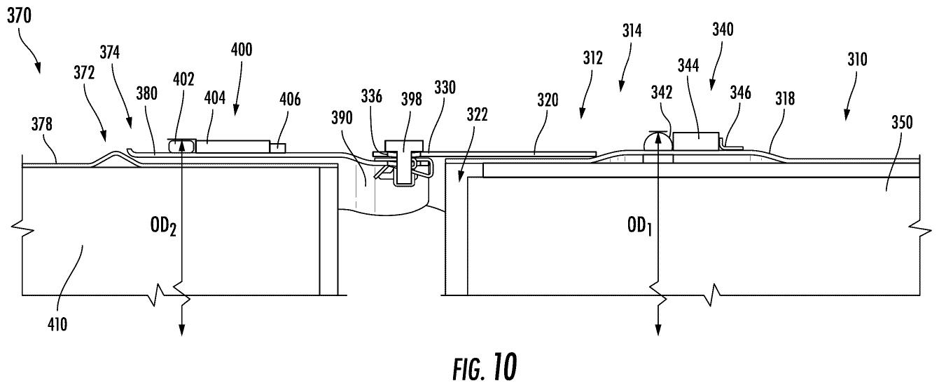

The diesel oxidation catalyst arcuate flange 390 has a second radius of curvature ρ₂. According to the exemplary embodiment shown in FIGS. 9 and 10, the second radius of curvature ρ₂ of the diesel oxidation catalyst arcuate flange 390 is smaller than the first radius of curvature ρ₁ such that portions of the diesel oxidation catalyst arcuate flange 390 are received by the diesel particulate filter arcuate flange 330 when the diesel oxidation catalyst assembly 370 is releasably coupled to the diesel particulate filter assembly 310. The first radius of curvature ρ₁ of the diesel particulate filter arcuate flange 330 and the second radius of curvature ρ₂ of the diesel oxidation catalyst arcuate flange 390 may be substantially similar to prevent movement between the diesel particulate filter assembly 310 and the diesel oxidation catalyst assembly 370. For example, the first radius of curvature ρ₁ of the diesel particulate filter arcuate flange 330 may be equal to 102% to 108% of the second radius of curvature ρ₂ of the diesel oxidation catalyst arcuate flange 390, inclusive. In other embodiments, the second radius of curvature ρ₂ of the diesel oxidation catalyst arcuate flange 390 is larger than the first radius of curvature ρ₁ such that portions of the diesel particulate filter arcuate flange 330 are received by the diesel oxidation catalyst arcuate flange 390 when the diesel oxidation catalyst assembly 370 is releasably coupled to the diesel particulate filter assembly 310. For example, the second radius of curvature ρ₂ of the diesel oxidation catalyst arcuate flange 390 may be equal to 102% to 108% of the first radius of curvature ρ₁ of the diesel particulate filter arcuate flange 330, inclusive.

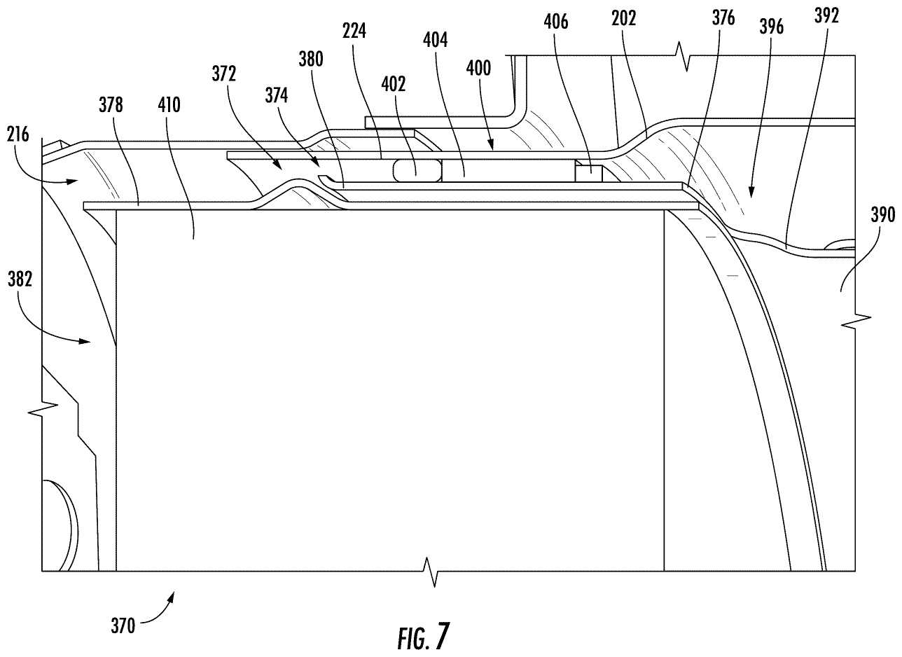

The diesel oxidation catalyst cylindrical body 374 includes a diesel oxidation catalyst body 378 (e.g., a catalyst body, etc.) and a diesel oxidation catalyst annular body 380 (e.g., a second annular body, a second crown ring annular body, a diesel oxidation catalyst crown ring body, a second housing annular body, a diesel oxidation catalyst housing body, etc.). The diesel oxidation catalyst annular body 380 is coupled to the diesel oxidation catalyst body 378. According to the exemplary embodiment shown in FIGS. 7, 9, and 10, the diesel oxidation catalyst seal assembly 400 is coupled to the outer surface of the diesel oxidation catalyst annular body 380. In other embodiments, the diesel oxidation catalyst seal assembly 400 is coupled to an outer surface of the diesel oxidation catalyst body 378.

The diesel oxidation catalyst body 378 defines a diesel oxidation catalyst cavity 382 (e.g., a catalyst body opening, a second body cavity, etc.) extending through diesel oxidation catalyst body 378. The diesel oxidation catalyst substrate assembly 410 may be at least partially disposed within the diesel oxidation catalyst cavity 382. In some embodiments, the diesel oxidation catalyst substrate assembly 410 may be coupled to the diesel oxidation catalyst body 378 when the diesel oxidation catalyst substrate assembly 410 is disposed within the diesel oxidation catalyst cavity 382 of the diesel oxidation catalyst body 378. The diesel oxidation catalyst annular body 380 defines the diesel oxidation catalyst cylindrical body edge 376 of the diesel oxidation catalyst cylindrical body 374. For example, a first side (e.g., an inner side, a downstream side, etc.) of the diesel oxidation catalyst annular body 380 may be coupled to the diesel oxidation catalyst body 378 and an opposing second side (e.g., an outer side, an upstream side, etc.) of the diesel oxidation catalyst annular body 380 may define the diesel oxidation catalyst cylindrical body edge 376 such that the diesel oxidation catalyst arcuate flange 390 extends from the diesel oxidation catalyst annular body 380.

The diesel oxidation catalyst cylindrical body edge 376 of the diesel oxidation catalyst housing 372 and diesel oxidation catalyst arcuate flange lateral edges 392 (e.g., second lateral edges, etc.) of the diesel oxidation catalyst arcuate flange 390 collectively define a diesel oxidation catalyst opening 394 (e.g., a second opening, a second sampling tube opening, etc.). The diesel oxidation catalyst opening 394 extends from the diesel oxidation catalyst cylindrical body edge 376 between the diesel oxidation catalyst arcuate flange lateral edges 392. The diesel oxidation catalyst arcuate flange 390 defines a diesel oxidation catalyst arcuate flange aperture 396 (e.g., a second aperture, etc.) extending through the diesel oxidation catalyst arcuate flange 390. In some embodiments, the diesel oxidation catalyst body 378 extends past the diesel oxidation catalyst cylindrical body edge 376 and blocks at least a portion of the diesel oxidation catalyst opening 394. The diesel oxidation catalyst arcuate flange aperture 396 selectively align with the diesel particulate filter arcuate flange aperture 336 to receive a fastener 398 to releasably couple the diesel oxidation catalyst assembly 370 to the diesel particulate filter assembly 310. In other embodiments, the diesel oxidation catalyst arcuate flange 390 may be releasably coupled to the diesel particulate filter arcuate flange 330 through other means (e.g., snap fit, adhesive, etc.) to releasably couple the diesel oxidation catalyst assembly 370 to the diesel particulate filter assembly 310.

When the diesel particulate filter arcuate flange 330 is releasably coupled to the diesel oxidation catalyst arcuate flange 390, the diesel particulate filter opening 334 align with the diesel oxidation catalyst opening 394. When the filter cartridge assembly 300 is received by the aftertreatment housing 202, the sampler tube 230 may be received by and extend through the diesel particulate filter opening 334 and the diesel oxidation catalyst opening 394 such that at least a portion of the sampler tube 230 is positioned between the diesel particulate filter assembly 310 and the diesel oxidation catalyst assembly 370. When the sampler tube 230 extends through the diesel particulate filter opening 334 and the diesel oxidation catalyst opening 394, the sampler tube 230 may receive the exhaust from between the diesel particulate filter substrate assembly 350 and the diesel oxidation catalyst substrate assembly 410 and provide the exhaust to the sensors 148 of the sampling unit 146.

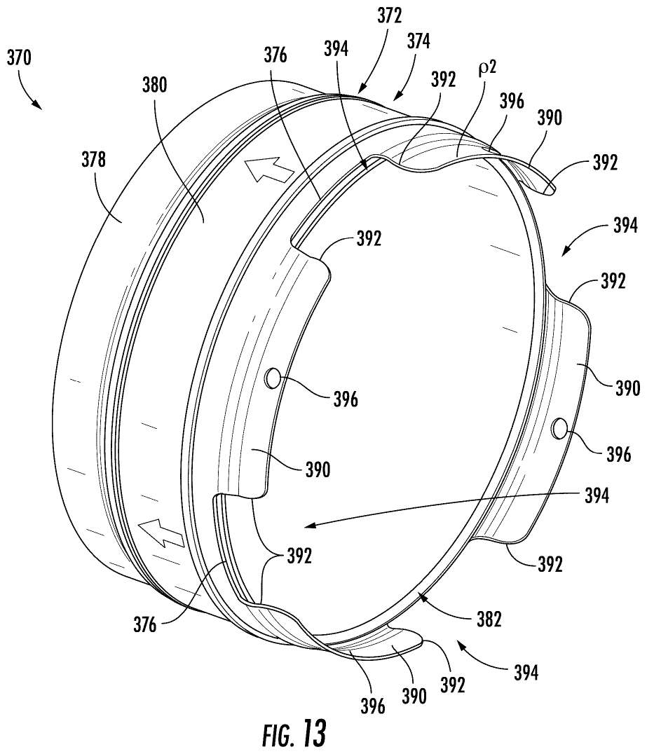

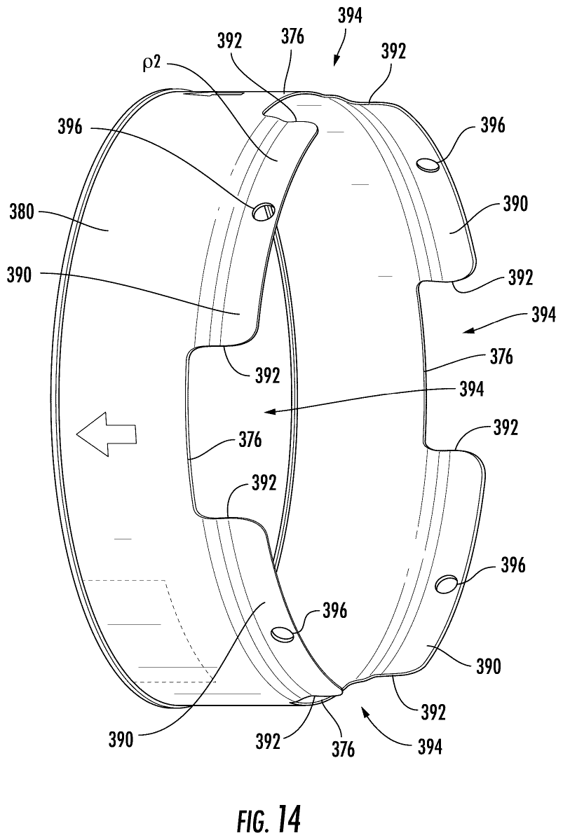

According to the exemplary embodiment shown in FIGS. 9, 13, and 14, the diesel oxidation catalyst housing 372 includes a plurality of the diesel oxidation catalyst arcuate flanges 390 (e.g., two of the diesel oxidation catalyst arcuate flanges 390, three of the diesel oxidation catalyst arcuate flanges 390, four of the diesel oxidation catalyst arcuate flanges 390, etc.) extending from the diesel oxidation catalyst cylindrical body edge 376 of the diesel oxidation catalyst cylindrical body 374. The diesel oxidation catalyst cylindrical body edge 376 of the diesel oxidation catalyst housing 372 and the diesel oxidation catalyst arcuate flange lateral edges 392 of the diesel oxidation catalyst arcuate flanges 390 collectively define a plurality of the diesel oxidation catalyst openings 394 (e.g., a third opening, a fourth opening, etc.). For example, when diesel oxidation catalyst housing 372 includes two of the diesel oxidation catalyst arcuate flanges 390, (i) the diesel oxidation catalyst cylindrical body edge 376, a first of the diesel oxidation catalyst arcuate flange lateral edges 392 of a first of the diesel oxidation catalyst arcuate flanges 390, and a first of the diesel oxidation catalyst arcuate flange lateral edges 392 of a second of the diesel oxidation catalyst arcuate flanges 390 may collectively define a first of the diesel oxidation catalyst openings 394 and (ii) the diesel oxidation catalyst cylindrical body edge 376, an opposing second of the diesel oxidation catalyst arcuate flange lateral edges 392 of the first of the diesel oxidation catalyst arcuate flanges 390, and an opposing second of the diesel oxidation catalyst arcuate flange lateral edges 392 of the second of the diesel oxidation catalyst arcuate flanges 390 may collectively define a second of the diesel oxidation catalyst openings 394. When the diesel particulate filter arcuate flanges 330 are releasably coupled to the diesel oxidation catalyst arcuate flanges 390, the diesel particulate filter openings 334 each align with one of the diesel oxidation catalyst openings 394. Each of the diesel oxidation catalyst arcuate flanges 390 may define one of the diesel oxidation catalyst arcuate flange apertures 396 extending through the diesel oxidation catalyst arcuate flanges 390. The diesel oxidation catalyst arcuate flange apertures 396 each selectively align with one of the diesel particulate filter arcuate flange aperture 336 to receive one of the fasteners 398 to releasably couple the diesel oxidation catalyst assembly 370 to the diesel particulate filter assembly 310.

The diesel oxidation catalyst seal assembly 400 includes a diesel oxidation catalyst seal element 402 (e.g., a second seal element, etc.) a diesel oxidation catalyst seal support 404 (e.g., a second seal support, etc.), and a diesel oxidation catalyst seal retaining ring 406 (e.g., a second retaining ring, etc.). The diesel oxidation catalyst seal element 402 is configured to contact the second inner surface 224 of the cavity 216 to form the second seal between the diesel oxidation catalyst assembly 370 and the second inner surface 224 such that exhaust flowing through the diesel particulate filter cylindrical body edge 316 cannot flow between the diesel oxidation catalyst assembly 370 and the aftertreatment housing 202 (e.g., around an outside of the diesel oxidation catalyst assembly 370, etc.). The diesel oxidation catalyst seal element 402 may be formed from a silica rope. The diesel oxidation catalyst seal support 404 is positioned downstream of the diesel oxidation catalyst seal element 402. For example, the diesel oxidation catalyst seal support 404 may be positioned closer to the diesel oxidation catalyst arcuate flanges 390 than the diesel oxidation catalyst seal element 402. The diesel oxidation catalyst seal support 404 is configured to support the diesel oxidation catalyst seal element 402 against a flow of the exhaust against the diesel oxidation catalyst seal element 402. The diesel oxidation catalyst seal support 404 may be formed from a wire mesh. The diesel oxidation catalyst seal retaining ring 406 is coupled to the diesel oxidation catalyst cylindrical body 374 downstream of the diesel oxidation catalyst seal support 404. For example, the diesel oxidation catalyst seal retaining ring 406 may be positioned closer to the diesel oxidation catalyst arcuate flanges 390 than the diesel oxidation catalyst seal support 404. The diesel oxidation catalyst seal retaining ring 406 is configured to support the diesel oxidation catalyst seal support 404 against the flow of the exhaust against the diesel oxidation catalyst seal element 402.

The diesel oxidation catalyst seal assembly 400 has a second outer diameter OD₂. The second outer diameter OD₂ of the diesel oxidation catalyst seal assembly 400 may correspond with the second diameter D₂ of the second inner surface 224 so that the diesel oxidation catalyst seal assembly 400 and the second inner surface 224 form the second seal between the diesel oxidation catalyst assembly 370 and the aftertreatment housing 202. The second outer diameter OD₂ of the diesel oxidation catalyst seal assembly 400 is less than the first outer diameter OD₁ of the diesel particulate filter seal assembly 340. As a result, when the filter cartridge assembly 300 is installed into the cavity 216 through the cavity aperture 218, the diesel oxidation catalyst seal assembly 400 may pass by the first inner surface 222 to contact the second inner surface 224 without catching on (e.g., contacting, snagging on, etc.) the first inner surface 222, which could damage the diesel oxidation catalyst seal assembly 400 and cause an improper seal between the diesel oxidation catalyst seal assembly 400 and the sealing cap assembly 240.

### IV. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, exhaust gas, liquid reductant, gaseous reductant, aqueous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W to P, etc.) herein are inclusive of their maximum values and minimum values (e.g., W to P includes W and includes P, etc.), unless otherwise indicated. Furthermore, a range of values (e.g., W to P, etc.) does not necessarily require the inclusion of intermediate values within the range of values (e.g., W to P can include only W and P, etc.), unless otherwise indicated.

What is claimed is:

1. A filter cartridge assembly for an aftertreatment unit, the filter cartridge assembly comprising:
a diesel particulate filter assembly comprising:
a diesel particulate filter housing comprising:
a first cylindrical body, and
a first arcuate flange extending from an edge of the first cylindrical body, wherein the edge of the first cylindrical body and lateral edges of the first arcuate flange collectively define a first opening, and
a diesel particulate filter substrate assembly disposed within the first cylindrical body; and
a diesel oxidation catalyst assembly comprising:
a diesel oxidation catalyst housing comprising:
a second cylindrical body, and
a second arcuate flange extending from an edge of the second cylindrical body, the second arcuate flange removably coupled to the first arcuate flange to releasably couple the diesel oxidation catalyst housing to the diesel particulate filter housing, wherein the edge of the second cylindrical body and lateral edges of the second arcuate flange collectively define a second opening, and
a diesel oxidation catalyst substrate assembly disposed within the second cylindrical body.

2. The filter cartridge assembly of claim 1, wherein a first radius of curvature of the first arcuate flange is equal to 102% to 108% of a second radius of curvature of the second arcuate flange, inclusive, such that portions of the second arcuate flange are received within the first arcuate flange.

3. The filter cartridge assembly of claim 1, further comprising:
a fastener; wherein:
the first arcuate flange includes a first aperture;
the second arcuate flange includes a second aperture aligned with one of the first aperture; and
the fastener is received by the first aperture and the second aperture to releasably couple the diesel oxidation catalyst housing to the diesel particulate filter housing.

4. The filter cartridge assembly of claim 1, wherein:
the diesel particulate filter assembly further comprises a first seal assembly having a first outer diameter; and
the diesel oxidation catalyst assembly further comprises a second seal assembly having a second outer diameter, the second outer diameter less than the first outer diameter.

5. The filter cartridge assembly of claim 1, wherein:
the first cylindrical body comprises:
a diesel particulate filter body in which the diesel particulate filter substrate assembly is disposed, and
a first annular body coupled to the diesel particulate filter body, the first annular body defining the edge of the first cylindrical body; and
the second cylindrical body comprises:
a diesel oxidation catalyst body, the diesel oxidation catalyst substrate assembly disposed within the diesel oxidation catalyst body, and
a second annular body coupled to the diesel oxidation catalyst body, the second annular body defining the edge of the second cylindrical body.

6. The filter cartridge assembly of claim 5, wherein:
the diesel particulate filter assembly further comprises a first seal assembly having a first outer diameter, the first seal assembly positioned on an outer surface of the diesel particulate filter body; and
the diesel oxidation catalyst assembly further comprises a second seal assembly having a second outer diameter, the second outer diameter less than the first outer diameter, the second seal assembly positioned on an outer surface of the second annular body.

7. An aftertreatment unit for an exhaust aftertreatment system, the aftertreatment unit comprising:
an aftertreatment housing defining a cavity; and
the filter cartridge assembly of claim 1 received by the cavity;
wherein:
the diesel particulate filter assembly further comprises a first seal assembly configured to contact a first inner surface of the cavity such that a first seal is formed between the first inner surface and the diesel particulate filter assembly,
the diesel oxidation catalyst assembly further comprises a second seal assembly configured to contact a second inner surface of the cavity such that a second seal is formed between the second inner surface and the diesel oxidation catalyst assembly, and
a first diameter of the first inner surface is greater than a second diameter of the second inner surface.

8. An aftertreatment unit for an exhaust aftertreatment system, the aftertreatment unit comprising:
an aftertreatment housing defining a cavity;
the filter cartridge assembly of claim 1, the filter cartridge assembly disposed within the cavity; and
a sampler tube coupled to the aftertreatment housing, the sampler tube extending into the cavity and through the first opening and the second opening, the sampler tube configured to receive exhaust from between the diesel particulate filter substrate assembly and the diesel oxidation catalyst substrate assembly.

9. The filter cartridge assembly of claim 1, further comprising:
the edge of the first cylindrical body and the lateral edges of the first arcuate flange collectively define a third opening; and
the edge of the second cylindrical body and the lateral edges of the second arcuate flange collectively define a fourth opening.

10. A filter cartridge assembly for an aftertreatment unit, the filter cartridge assembly comprising:
a diesel particulate filter assembly comprising:
a diesel particulate filter housing comprising:
a first cylindrical body, and
a first arcuate flange extending from an edge of the first cylindrical body, wherein the first arcuate flange includes a first aperture, and
a diesel particulate filter substrate assembly disposed within the first cylindrical body;
a diesel oxidation catalyst assembly comprising:
a diesel oxidation catalyst housing comprising:
a second cylindrical body, and
a second arcuate flange extending from an edge of the second cylindrical body, wherein the second arcuate flange includes a second aperture aligned with one of the first aperture, and
a diesel oxidation catalyst substrate assembly disposed within the second cylindrical body; and
a fastener received by the first aperture and the second aperture to releasably couple the diesel oxidation catalyst housing to the diesel particulate filter housing.

11. The filter cartridge assembly of claim 10, wherein a first radius of curvature of the first arcuate flange is equal to 102% to 108% of a second radius of curvature of the second arcuate flange, inclusive, such that portions of the second arcuate flange are received within the first arcuate flange.

12. An aftertreatment unit for an exhaust aftertreatment system, the aftertreatment unit comprising:
an aftertreatment housing defining a cavity; and
the filter cartridge assembly of claim 10 received by the cavity; wherein:
the diesel particulate filter assembly further comprises a first seal assembly configured to contact a first inner surface of the cavity such that a first seal is formed between the first inner surface and the diesel particulate filter assembly,
the diesel oxidation catalyst assembly further comprises a second seal assembly configured to contact a second inner surface of the cavity such that a second seal is formed between the second inner surface and the diesel oxidation catalyst assembly, and
a first diameter of the first inner surface is greater than a second diameter of the second inner surface.

13. An aftertreatment unit for an exhaust aftertreatment system, the aftertreatment unit comprising:
an aftertreatment housing defining a cavity;
the filter cartridge assembly of claim 10, the filter cartridge assembly disposed within the cavity; and
a sampler tube coupled to the aftertreatment housing, the sampler tube extending into the cavity and between the first arcuate flange and the second arcuate flange, the sampler tube configured to receive exhaust from between the diesel particulate filter substrate assembly and the diesel oxidation catalyst substrate assembly.

14. The filter cartridge assembly of claim 10, wherein:
the first cylindrical body comprises:
a diesel particulate filter body, the diesel particulate filter substrate assembly disposed within the diesel particulate filter body, and
a first annular body coupled to the diesel particulate filter body, the first annular body defining the edge of the first cylindrical body; and
the second cylindrical body comprises:
a diesel oxidation catalyst body, the diesel oxidation catalyst substrate assembly disposed within the diesel oxidation catalyst body, and
a second annular body coupled to the diesel oxidation catalyst body, the second annular body defining the edge of the second cylindrical body.

15. The filter cartridge assembly of claim 10, wherein:
the diesel particulate filter assembly further comprises a first seal assembly having a first outer diameter; and
the diesel oxidation catalyst assembly further comprises a second seal assembly having a second outer diameter, the second outer diameter less than the first outer diameter.

16. A filter cartridge assembly for an aftertreatment unit, the filter cartridge assembly comprising:
a diesel particulate filter assembly comprising:
a diesel particulate filter housing comprising:
a first cylindrical body, and
a first arcuate flange extending from an edge of the first cylindrical body,
a diesel particulate filter substrate assembly disposed within the first cylindrical body, and
a first seal assembly having a first outer diameter, and
a diesel oxidation catalyst assembly comprising:
a diesel oxidation catalyst housing comprising:
a second cylindrical body, and
a second arcuate flange extending from an edge of the second cylindrical body, the second arcuate flange removably coupled to the first arcuate flange to releasably couple the diesel oxidation catalyst housing to the diesel particulate filter housing,
a diesel oxidation catalyst substrate assembly disposed within the second cylindrical body, and
a second seal assembly having a second outer diameter, the second outer diameter less than the first outer diameter.

17. An aftertreatment unit for an exhaust aftertreatment system, the aftertreatment unit comprising:
an aftertreatment housing defining a cavity; and
the filter cartridge assembly of claim 16 received by the cavity; wherein:
the first seal assembly is configured to contact a first inner surface of the cavity such that a first seal is formed between the first inner surface and the diesel particulate filter assembly,
the second seal assembly is configured to contact a second inner surface of the cavity such that a second seal is formed between the second inner surface and the diesel oxidation catalyst assembly, and
a first diameter of the first inner surface is greater than a second diameter of the second inner surface.

18. The filter cartridge assembly of claim 16, wherein a first radius of curvature of the first arcuate flange is equal to 102% to 108% of a second radius of curvature of the second arcuate flange, inclusive, such that portions of the second arcuate flange are received within the first arcuate flange.

19. An aftertreatment unit for an exhaust aftertreatment system, the aftertreatment unit comprising:
an aftertreatment housing defining a cavity;
the filter cartridge assembly of claim 16, the filter cartridge assembly disposed within the cavity; and
a sampler tube coupled to the aftertreatment housing, the sampler tube extending into the cavity and between the first arcuate flange and the second arcuate flange, the sampler tube configured to receive exhaust from between the diesel particulate filter substrate assembly and the diesel oxidation catalyst substrate assembly.

20. The filter cartridge assembly of claim 1, further comprising:
a fastener; wherein:
the first arcuate flange includes a first aperture;
the second arcuate flange includes a second aperture aligned with one of the first aperture; and
the fastener is received by the first aperture and the second aperture to releasably couple the diesel oxidation catalyst housing to the diesel particulate filter housing.
